(19) United States
(12) Patent Application Publication
(10) Pub. No.: US 2008/0172254 A1
(43) Pub. Date: Jul. 17, 2008

(54) Method For Providing Electronic Medical Records

(76) Inventors: Eric Rosenfeld, Randolph, NJ (US); Milton Hauser, Cedar Knolls, NJ (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 12/014,281

(22) Filed: Jan. 15, 2008

Related U.S. Application Data
(60) Provisional application No. 60/880,662, filed on Jan. 16, 2007.

(51) Int. Cl. G06Q 50/00

(52) U.S. Cl. 705/3

(57) ABSTRACT

A system and method for collecting, aggregating and providing electronic medical records is presented. A patient enters information regarding medical services providers to a medical records service as part of a digital medical profile. The patient further submits a records authorization authorizing the release of the patient's medical records to the medical records service. Health care records are requested from each of the patient's medical services providers, and upon receipt, entered into a database. An interactive healthcare calendar permits a patient to enter medical appointments. Updates to the medical records are requested from relevant medical services providers at regular intervals, or after an appointment in the interactive healthcare calendar. The stored medical records are transferred to a portable records storage device such as a USB key, which may be carried by the patient for use by medical services providers, or in the case emergency medical treatment is needed.

### CROSS REFERENCE TO RELATED APPLICATIONS

This application claims priority from U.S. Provisional Patent Application Ser. No. 60/880,662, filed on Jan. 16, 2007.

### BACKGROUND

1. Technical Field

The present principles relate to a method for acquiring, compiling and providing electronic medical records.

2. Description of the Related Art

In recent years, the medical field has struggled to keep pace with the volume of patient records. As the amount of documentation required for medical procedures has flourished, the ability of patients and medical services providers to track and manage medical records has faltered. Electronic record keeping provides a method for compiling and aggregating the voluminous medical records that patients may accrue during their lifetime.

Experts within the industry, and within government, have called for a move from physical paper records to electronic medical records. The use of electronic medical records provides for greater record portability, lower risk of medical error, and increased treatment accuracy.

However, the use of a global medical data base, where practitioners all have unfettered access to patient medical records gives rise to serious patient privacy concerns. Such a medical records database and permitting multiple users to view a particular patient's information cold possibly create security problems, or allow non-medical personnel to access vital patient medical data.

### SUMMARY

Presented herein are a system and method for acquiring, compiling, and providing electronic medical records.

According to one aspect of the present principles, the method for providing a medical records service includes the steps of enrolling a patient, the enrolling comprising gathering information for at least one medical service provider of the patient, receiving a records authorization to gather medical records for the patient, requesting medical records from each of the medical services providers of the patient using the received records authorization, recording receipt of and entering the requested medical records into a database, and billing the patient for charges incurred in obtaining copies of the requested medical records.

According to another aspect of the present principles, the method for providing a medical records service for gathering and storing medical records of a patient, includes the steps of enrolling a patient, the enrolling comprising gathering information for at least one medical service provider of the patient, receiving a records authorization to gather medical records for the patient, requesting updated medical records from at least one of the medical service providers using the received records authorization, receiving the requested updated medical records, updating the medical records of the patient with the received updated medical records, and billing a patient for the costs incurred in connection with the requesting of updated medical records.

### BRIEF DESCRIPTION OF DRAWINGS

The disclosure will provide details in the following description of preferred embodiments with reference to the following figures wherein:

FIG. 1 is a flow diagram of the primary steps in the method for providing electronic medical records according to an implementation of the present principles;

FIG. 2 is a flow diagram of the enrollment process according to an implementation of the present principles;

FIG. 3 is a flow diagram of the authorization process according to an implementation of the present principles;

FIG. 4 is a flow diagram of the records request process according to an implementation of the present principles;

FIG. 5 is flow diagram of the records receipt process according to an implementation of the present principles; and

FIG. 6 is a flow diagram of the records billing process according to an implementation of the present principles.

### DETAILED DESCRIPTION

An improved system and method is presented for acquiring, compiling, and providing electronic medical records. In accordance with one useful implementation of the present principles, medical records may be gathered by a medical records service from a patient's various medical services providers, and aggregated and stored for the patient.

Here, the term “medical records” may be used to denote records of treatment, diagnosis, immunization, prescriptions, or any other record generated in connection with, or for the purpose of, medical treatment. Furthermore, the term “patient” may be used herein to reference an entity for which medical records are sought or stored, or to an entity seeking medical treatment or diagnosis. A patient may, for example, be an individual, a family or family member, an insurance policy holder or dependent, or a group of individuals such as a company or corporate group.

The implementations described here are relevant to electronic storage devices, computers, communications networks, web browsers, or any other system or device used for browsing ad storing informational resources such as web pages, documents, images, or the like.

Various embodiments of the present principles can take the form of an entirely hardware implementation, an entirely software implementation or an implementation including both hardware and software elements. According to one aspect, the present principles are implemented in software, which includes but is not limited to firmware, resident software, microcode, etc.

Furthermore, the present principles can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulls storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The methods and systems disclosed herein may be implemented as web pages accessed via a web browser. Alternatively, the system may be advantageously embodied as a standalone software program, or as any combination of standalone software and web pages. The system may tale on any form where software is capable of collecting, compiling, and providing medical records to a portable records storage device. Hereinafter, where the present principles are referred to as being embodied in software, any embodiment of the present principles may be implemented without deviating from the scope of the present principles.

Any modules or layers discussed as elements of an apparatus or system may be disposed on separate computing devices, or may be disposed, in any combination, on a single computing device, or across multiple computing devices. Skilled artisans will recognize that the physical deployment of modules is immaterial, as long as modules are communicatively connected to each other, where necessary.

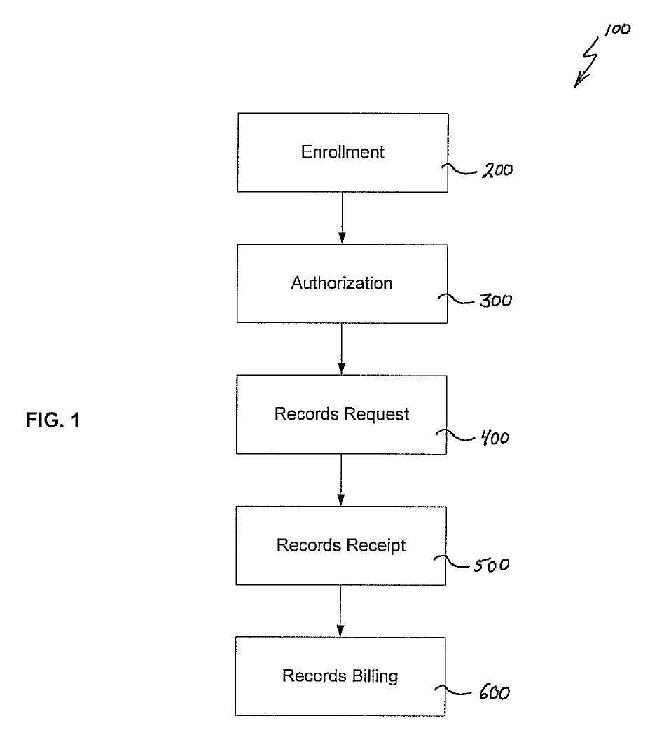

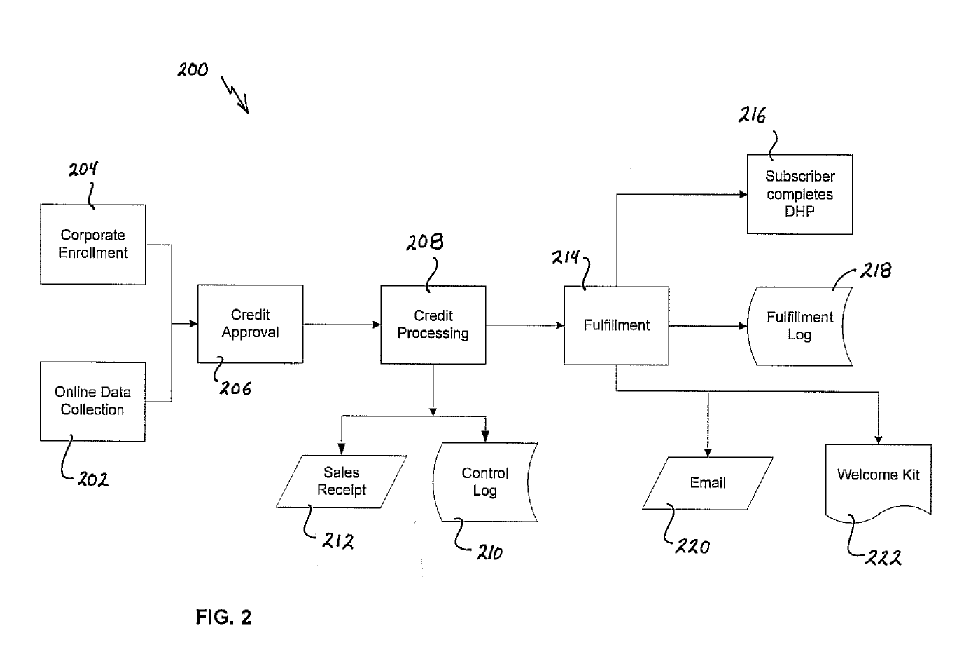

Referring now to FIG. 1, there is shown a high level flow diagram of the method 100 according to an implementation of the present principles. Initially, an enrollment 200 of the customer takes place, and an authorization 300 of the requested records is performed. Once authorized, the records request 400 is made, and a records receipt is confirmed at step 500. Once the records have been received 500, the records billing 600 is performed. The details of each of these steps are described now with reference to FIGS. 2-6.

Enrollment 200 occurs when a new member subscribes to the service. There are contemplated two types of service: 1) a Basic service which includes only the ability to store personal information as provided by the member; and 2) a Premium service which includes all the services of Basis, plus an extended set of online tools and record collection services as described below.

Enrollment 200 may occur as either a lice credit card transaction (i.e., a retail sale) or as a pre-paid membership (i.e., a corporate sale). Additionally, there may be discount or corporate pricing programs. These programs will define the actual cost of membership and renewals and are calculated at the time of enrollment based on the type of enrollment requested, including any combination of adults, senior citizens and children.

According to one aspect of the present principles, all enrollments are performed within an Internet browser session, as a series of programs produce a chain of web pages that the user navigates to enter information, confirm entry, and approve payment.

The enrollment process 200 culminates when all required information is completed and the transaction is approved. In the case of a retail transaction, the enrollment phase is immediately followed by a step-by-step tutorial where the user is shown the various components of their digital health profile, and asked to supply personal information about themselves, their family and their healthcare providers. In any event, the enrollment process itself is followed by fulfillment and authorization processes as now described.

Referring to FIG. 2, as mentioned above, the enrollment process is accomplished by the subscriber or their delegate using a set of Internet based programs and web pages. The subscriber first enters the type of membership and any referral or promotional “registration” code to define their intention to use corporate programs or discount pricing. The customer is then asked to confirm the details and accept pricing for the transaction. Finally, the customer enters their personal information and billing information, and chooses a username and password for their account. Enrollment is complete after the transaction is approved by the credit card processor or is otherwise confirmed as paid.

The corporate enrollment 204 entails the purchase of a number of memberships intended for use by whomever the purchaser designates. The corporate entity will generally make payment in advance based on a pre-negotiated per-person rate. This will entitle them to a specific number of memberships of a specified type.

The buyer may opt to arrange another promotional pricing arrangement to be used in conjunction With the corporate pre-paid memberships either to cover family members or other non-employees, or as an alternative once the pre-paid memberships have all been allocated.

The corporate enrollment process 204 is as follows:

a. Sales Department establishes a contract with the buyer;

b. A/R is informed and produces an invoice; and

c. Buyer executes contract and provides payment by check or credit card.

A/R receives payment and enters the payment and produces an operations memo for corporate account set up. The memo includes the payment status, amount, and number of memberships allowed. In addition, the memo stipulates the procedure for additional promotional pricing and whether group memberships may be established under the auspices of the pre-paid membership “block”

The operations staff establishes the account, and develops a unique promotional or registration code to be given to the buyer. The buyer will in turn share this code with their employees or other designees to be used at the time of individual sign up.

The prospective member enrolls in the service by going to the website and using the code they have been given. There are no charges made at the time of enrollment, but the member is still required to enter a credit card number to be stored in the system so that the system can charge the individual member for copy charges as involved by healthcare providers in the future, during record collection.

Most enrollments in system are conducted as online enrollments, using the web system. As such, the online data collection 202 is integral part of the program. This process establishes an account with Provider, which must include one or more subscribers. Multi-member accounts are also called group accounts of family accounts. When creating a group account, one of the members of that group will be designated as the primary member and will be responsible for the setup and administration of new members or family members under that account.

The data collection process is comprised of six distinct steps;

The subscriber chooses the service type they wish Mede File Basic or MedeFile Premium;

The subscriber enters a registration code if they have one (this identifies the specific pricing they will receive and/or their affiliation with a pre-paid corporate plan);

The subscriber chooses the number of members to enroll in the new account either establishing an individual account or a group account as described above;

The subscriber chooses a payment plan (either paid in full or to be paid in either four or twelve periodic payments;

The subscriber processes the order by pressing continue on the screen. The system then calculates all pricing discounts periodic payments etc and presents the invoice to the customer for their approval; and

The customer/subscriber approves the charges and then provides personal contact, billing, credit card, and identification information, including selecting a unique username.

The credit approval 206 is the next step once the online data collection 202 is complete. Once the data collection process is complete, the system charges the credit card, by formatting a specific transaction and then sending it to the credit card processor electronically, as an encrypted string of information over the Internet. The card processor performs routine analysis of the transaction, account, etc. and provides either an approval or rejection based on the combined set of information provided.

Once the transaction is approved, the provider's system completes the credit processing 208 by:

Scheduling future payments if necessary;

Establishing the account in the MedeFile database, including expiration and renewal scheduling;

Establishing username and password in the database to provide access for the member now that payment has been assured;

Sending the subscriber an email receipt (primary subscriber only); and

Creating database rows to contain payment information (amount, account, date, etc.) for accounts receivable reporting and interface.

The outputs or the credit processing step 208 are a sales receipt 212 and a control log 210. The sales receipt is produced by the system and emailed to the address given in the enrollment data collection step. The receipt contains details of the transaction as well as the member's ID number and information regarding contact, customer service and system access. In the present implementation the Control log(s) 210 include and audit control log and a transaction control log. The audit Control Log(s) 210 is maintained on this activity, as it is with any activity in the system that affects, changes, or adds information to the system's database. This audit trail is accessible by the member. A transaction control log is also created that enables the operations staff to identify that a new member has just joined and that authorization, fulfillment, etc. will shortly follow.

The next step is fulfillment 214. At this stage, a member-ship “welcome kit” is assembled containing at least the following materials in addition to any relevant promotional literature:
Personalized membership card;
Blank Personal records storage (PRS) device. The PRS is the subject of another pending U.S. patent application Ser. No. 11/895,596, filed on Aug. 24, 2007, the entire contents of which is incorporated herein by reference;
P Instructions;
Blank authorization form;
Blank signature card; and
Stickers and Service provider pin.

Some of this content is produced by the Service provider's system directly, including the address label. The welcome kits are preferably band-assembled and shipped via postal mail. In addition an email is sent to the member containing a copy of the blank authorization form.

The email output 220 includes the authorization form and signature card to the primary member as PDF (adobe acrobat) file so that they can get them filled out and back to the service provider as soon as possible.

The welcome kit output 222 is a collection of forms, and materials (described above) that enable the member to become acquainted with the service itself, and also provide the requisite forms to enable record collection.

In addition, a fulfillment log 218 is created that enables operations to establish a tickler file for follow up on those memberships that have not yet completed and returned authorization forms that are required to begin the collection process.

In addition to the above, upon fulfillment, the subscriber completed a DHP form 216. The Digital Health Profile (DHP) is a collection of programs that: collect primary healthcare information for a member and which are used to collect records. This information includes:
General health data height weight blood type etc;
Physicians name address specialty telephone and fax numbers;
a Hospitals: name, address, telephone and fax numbers;
Allergies: type, substance, severity, onset;
Emergency Contact information: name address, telephone and fax number;
a Family History: (by disease type) for parents, siblings, grandparents, etc.;
a Medical Conditions: by disease and symptom: type, and onset;
Pharmacies name, address, telephone and fax numbers; and

Medications: name, dosage, frequency, start and end dates.

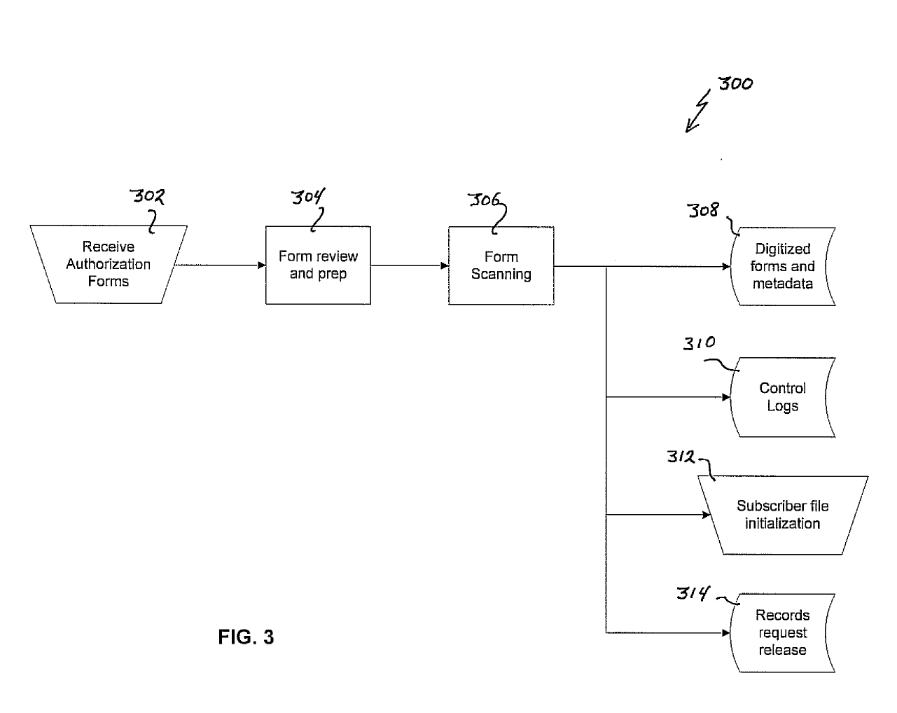

The authorization step 300 is described with reference to FIG. 3. The Authorization is important since the service provider cannot simply request records without proof that the patient has: 1) requested them to do so; 2) is aware of and active in the request; and, 3) understands the implications according to HIPAA regulations. All authorization materials are scanned and stored electronically so that they may be used automatically by system processes during the collection process.

The authorization process enables the service provider to collect records on a patient's behalf by:
Collecting a dated, durable, HIPAA compliant authorization that is notarized and signed, establishing both the patient's identity and the right to collect records for the ensuing 12 months; and
Collecting a signature card that can be-used for specific records requests to healthcare providers.

Initially, the authorization forms are received 302. Generally the forms are received in postal mail and sorted by band. It is further contemplated that authorization forms could be received electronically. There are two types of forms used in the service provider's system: 1) a blanket authorization form; and 2) a signature card. Each type is scanned separately, so they must be collected, and collated so that each may be scanned appropriately.

The next step is form review and preparation 304. Prior to scanning, each form of each type must be reviewed for completeness, to make sure it is signed, dated, and in the case of the blanket authorization, notarized appropriately. The subscriber ID number must also be placed on each form prior to scanning. The forms are then scanned 306, preferably using digital high speed scanners. The scanners are driven by a computer program that obtains the image, corrects and crops it as needed, and then places the image onto the server where it will be stored as a file. The computer programs also place information into the service provider's database about the images including filename, dates, etc. Finally, control logs 310 of the operation are kept that include a process log for operations tracking and an audit trail log for the member that notes the date and time of the operation.

There are several outputs provided from the authorization process 300. For example, the scanning creates a digitized form and generates meta data 308. Generally, a TIF image of each form is placed on a server as a file in a directory. Information about this file (e.g., meta data) is placed in the database attached to the specific subscriber's record. As mentioned above, there are control logs 310 that are maintained. The two types of control logs are operation logs and audit logs. The operations logs are kept to note that the subscriber has returned paperwork and that records may now be collected on their behalf, and an audit trail record or log of the scanning operation is made to the patient's record to note that the service provider has received and processed their paperwork.

The subscriber file initialization 312 consists of a paper file that is generated at the service provider's headquarters. This file will contain all paper account information on record for that client and will also contain any correspondence with that client. The processed authorization forms are then placed in that file. The records release request 314 provides the appropriate database information to enable automatic collection of records to proceed.

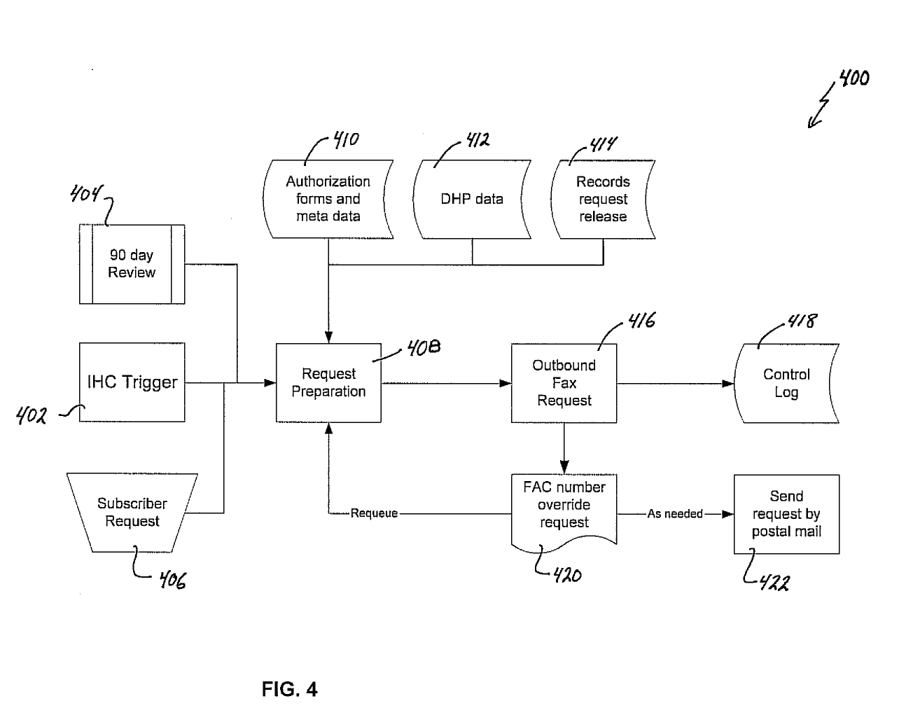

FIG. 4 shows the Records Request process 400 according to an implementation of the present principles. The records request mechanism begins the process of medical record collection for each subscriber. During this stage of the process, the service provider's system automatically prepares and sends formatted requests for records to each doctor and hospital identified by the patient. Furthermore, while the process initially uses the patient provided contact information for the provider, it will correct any misstated information such as incorrect fax numbers or contact data as it proceeds.

The system will automatically request records from each provider for any subscriber having current authorizations on file, provided that—the subscriber has marked the provider as-currently active and has set the request depth (the number of months of records the subscriber wishes us to retrieve) appropriately. Subscribers may opt to mark a provider as inactive, thereby exempting that provider from the records collection process. The end result of this process is that each provider will be given a HIPAA compliant request for information via fax or postal mail.

This process will be triggered by one of several criteria: 1) Interactive Healthcare Calendar (IHC) trigger 402; 2) 90 day review 404; or 3) subscriber request 406. The Interactive Healthcare Calendar (IHC) is a service provider System feature that enables subscribers to keep track of appointments with healthcare providers. The records collection process is sensitive to this calendar and will automatically cause a records request to be made after the appointment, in order to obtain updated records that were presumably created at that time.

Immediately upon authorization and then again every 90 days (404), the system will send a request to each provider for every active subscriber. The nature of any repeat request includes the most recent date of any records already received, so that no duplicate records are ever requested. Alternatively, the subscriber may manually enter a request 406 using the web base system. In this case, the request is processed immediately.

Once any one of the three (3) triggering events occur, the Request preparation 408 is performed. During this process the system automatically constructs the request, forming a header page, the actual request, and attaching a copy of the subscriber's notarized authorization form and a return fax cover sheet, in the event the provider wishes to supply the records by return fax. The actual request page is comprised of boilerplate request language and the following content:

The signature of the patient (from the signature card scanned during authorization discussed above);

A bar-coded subscriber id and id for the provider to be used when records are returned;

The date of the most recent record already on file for that provider and subscriber (to avoid duplicate requests);

The date of the request, name and address of the provider; and

Instructions on how to return records.

There are several inputs for Request preparation 408. The Authorization Forms and Meta data 410 are the forms and data created during the authorization process and are used here to form the request itself. The patient's signature appears on the request and the authorization form is included as well. Additionally, in order to qualify for records collection, the subscriber's account must remain current (not in arrears if paid monthly) and must remain unexpired (i.e., renewed) if older than one year. The contact information for each provider is obtained (at least initially) from the digital health profile (DHP) data 412 entered by each subscriber. Subscribers may add doctors or hospitals to this list at any time. Subscribers are required to provide both postal, telephone, and fax contact information for each provider.

In addition to the authorization forms and meta data 410, DHP data 412, there is also a Records request release 414 which is a combination of the completion and availability of authorization information, enrollment information, and provider information. This information is necessary to complete the formation of the request.

Once the request preparation is completed or formed, the requests are automatically faxed-to the provider in and outbound fax request 416 and a log 418 of the request is made. Requests may be followed up every 2 weeks after initial contact, if no communication or correspondence is received from the provider This repeat contact may be made by fax or phone depending on the nature of the follow up required. If for some reason the provider's fax is unresponsive or there is an error in the transmission, the system will automatically respond by either re-queuing the fax, or sending it to the service provider's operations group, who will further handle the request. The operations group may opt to override the request 420.

Occasionally, subscribers will enter incorrect contact information for a provider, or omit information entirely. In this case the fax will not complete and, the operations group will receive the request automatically. The operations group will have the option of overriding the fax number with a corrected one (420), or changing that address or other contact information as a result of research they conduct on a case by case basis. The operations group can then choose to re-queue the fax request after correcting the information, and as needed can send the request by postal mail 422. This may be required due to hospital regulations or policy or because the provider does not have a fax machine.

As mentioned above with respect to other processes, the control log 418 is maintained and generally includes two control logs:
Operations logs are kept to note each request and to set up manual follow-up, if needed; and
An audit trail record of the request process is made and is available to the subscriber.

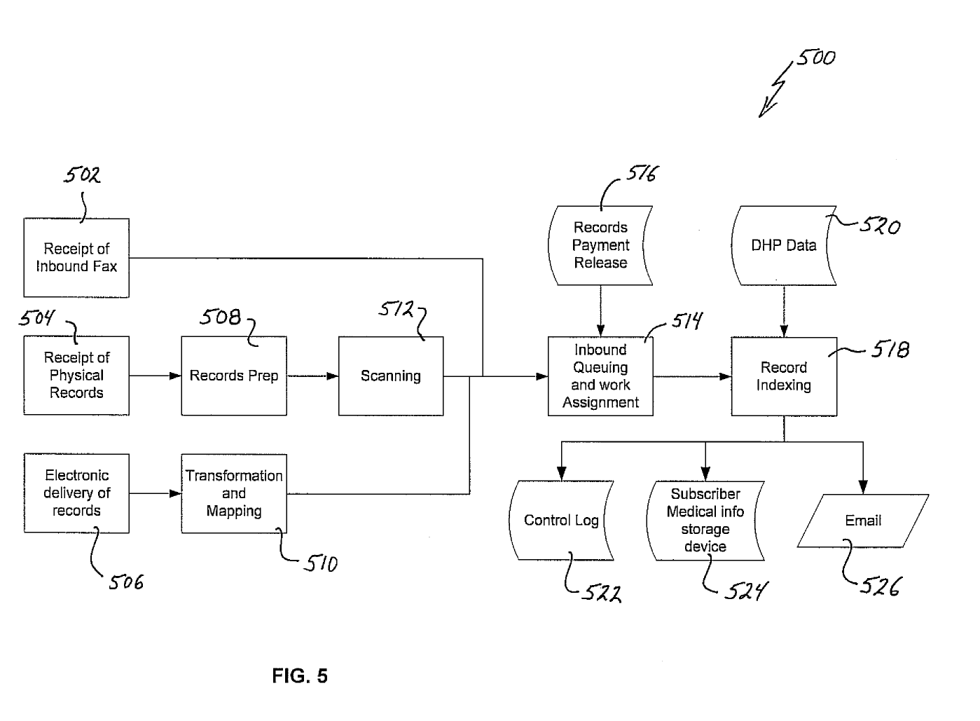

FIG. 5 shows the records receipt process 500 according to an implementation of the present principles. Once records are returned by the provider, they must be processed in order to be placed in the subscriber's storage device or “vault” (e.g., a data base and filed system made up of the actual medical records and the metadata about the records as keyed by subscriber, provider and record type). The processing includes converting the paper records (if delivered by postal mail) to electronic form and indexing the records so that they can be placed appropriately, by subscriber, record type and provider into the subscriber's storage device (e.g., a medical record storage device).

As mentioned above, the subscriber's “vault” is a database and file system comprised of the actual medical records and metadata about the records and keyed by subscriber, provider and record type. This enables the subscriber to access, sort, and filter records of various types by a number of criteria. Those of skill in the art will recognize that since medical records can become voluminous over time, this capability is crucial.

The records receipt process 500 has been developed to maximize the scalability of the records processing function as well as to enable it to be completed anywhere there is an Internet connection. All records sorting and indexing functions are enacted over the Internet, using thin-client web browser programs that have been secured so that only service provider staff can access them.

The records receipt process 500 can be triggered by any one of three (3) events. More specifically, the receipt of an inbound fax 502, the receipt of physical records 504, or the electronic delivery of records 506. When records arrive via incoming fax (502), they are automatically deposited into the inbound work queue 514 for processing. Whenever possible, the incoming phone number is also placed on the transmission so that the operator can identify the origin of the fax if that is uncertain. Ordinarily, the faxes are sent using the cover sheet supplied in the request process (see above). This cover sheet contains indexing information for both patient and provider.

When records arrive via mail (504), they are first reviewed for completeness, length, etc. and then sent to records preparation 508 in order to be scanned 512 into digital format. In some cases, records are provided in a digital or electronic format (506). These records may arrive via postal mail or other means, but must first be segregated by type and examined to determine how best to incorporate them into the system. This process is performed by the service provider's Information Technology (IT) organization, which may require additional programming to be custom-built to accommodate the process.

Upon arrival of physical records 504, they must be prepared for scanning. This is part of the records preparation step 508 and can include separating them and removing staples, paper clips, etc. as well as manually reviewing the record to make sure they are all for the intended patient and that there is no problems with clarity. In some cases the records are re-requested if they are incorrect or unclear.

The scanning process 512 digitizes the paper records, one page at a time, and places the resulting set of pages into the work queue 514, in order to be indexed. This is currently performed using high speed scanning, but could also be performed by faxing the paper records into the service provider's system.

When the records are received electronically (506), they are processed in a transformation and mapping step 510. Given the very large variety of digital formats and file types available, records presented in an electronic format must first be analyzed and then converted into a format appropriate for storage in the subscriber's vault. In some cases, accompanying meta-information (i.e., information about the records themselves such as date, record type, etc.) must be transformed for placement in the service provider's database. Once the programming is made available, the incoming electronic records are “transformed” and placed in the work queue so that they may be indexed (or confirmed as-is, if possible) and placed in the Member's MedeVault.

The inbound queuing and work assignment 514 is available to the Operations staff identified as records processors. This queue lists all incoming record sets that require indexing. To begin the indexing process, a staff member “reserves” a record set, which is a set of pages, sent all at once from one source into the service provider's system. This is ordinarily for a single patient.

Once reserved, a queue entry becomes unavailable to others until it is completely processed and placed in the Subscriber's vault. In this way, incoming record sets are assigned on a first-come-first-served basis to the service provider's staff, who will work on them henceforth.

In some cases, invoices for the incoming records will accompany the records themselves, especially when those records arrive in a physical format. In this case, we must await payment clearance or release (516) for the records prior to processing them. (See records payment below). If the record arrives without an accompanying invoice, they are processed normally.

Once the record set is reserved from the work-queue by the service provider's Operations staff member, it is examined and indexed (518) one page at a time. Each page is considered a separate record and each page must be identified with the following information:

a. •Subscriber identifier

b. •Provider identifier

c. •Date of the record

d. •Record Type

e. •This process indexing process 518 has three steps:

1) The record image is examined by the staff member. The staff member either enters the subscriber ID or performs a search based on record content to determine the subscriber ID. Once identified, the entire record set (and all pages therein) are considered to be associated with that subscriber's identifier;

2) The record image is also examined to determine the provider. The provider can be chosen from a drop-down list of providers for the subscriber identified in step 1; and

3) Each page is then examined in detail to determine the type of record and the date of the record. In some cases, pages can be “ignored” or passed over because either it does not contain information, or is not generated by the provider (i.e., header pages, patient forms, extraneous data, etc.).

Once the indexing is complete for the record, and all pages have been assigned record types or marked as “ignored”, the entire record set is placed into the database, and made accessible to the member.

As an input to the record indexing 518 the DHP data 520 provides the provider's information needed to identify record sources and mark each record. The outputs to the record indexing 518 includes the control log 522, the subscriber medical info storage device (vault) 524 and email 526.

Files and Meta data are placed in the subscriber medical info vault (i.e., database and file system) and are immediately available to members. As like the other operations discussed above, the control logs 522 includes two logs: 1) Operations logs that are updated to denote the receipt and processing of the records. This affects any pending follow-up with providers to confirm record receipt; and 2) An audit trail record of the records indexing process is made and is available to the subscriber. The email notification 526 makes subscribers aware that new records are available. This email notification is sent automatically when the records are available.

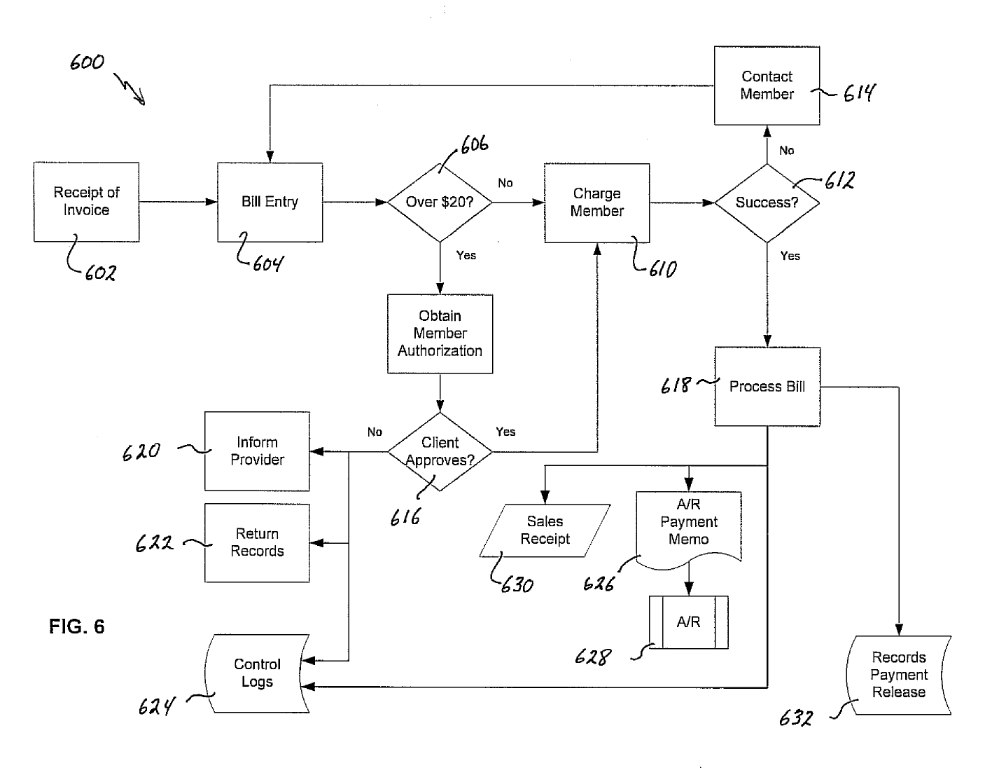

FIG. 6 shows the records billing process 600 according to an implementation of the present principles. In most cases, providers charge for the records they provide to the service provider. These charges are passed along to the member directly, on a penny-for-penny basis. However, to avoid overwhelming the subscriber with numerous petty charges, the service provider will automatically charge the member for any charge under $20.00. Charges in excess of $20.00 generate an email requesting authorization from the member. In the event that the member rejects the charges, the invoice is returned unpaid to the doctor, along with any records that accompanied (or precede) it.

Initially the process 600 begins upon receipt of an invoice 602. The invoice from the provider must arrive prior to starting this process. The receipt of physical records may also accompany the invoice or precede it. Since there are statutory limits to the amount a provider may charge a patient for recovery of their records, the number of pages is often a critical statistic in the evaluation of a prospective invoice. If records do not accompany or precede an invoice, the Operations staff will contact the provider or their copy service to determine the basis for the charge prior to payment.

Upon receipt, details of the invoice are input (604) into the billing system. These details include provider, subscriber, amount, whether records were received or not, the number of pages covered by the charge, invoice identifiers, tax id, etc. At this point, the pending charge is given a unique id and placed in the database pending further action. This information will follow the invoice throughout the rest of the processing.

The system offers a differential billing processing. If the amount of the charge is $20 or less (Step 606), the charge is immediately processed (step 610) with the credit card company using the card on file for the member's account. Otherwise, the member is contacted for authorization (608) prior to processing the card. If the charge is unsuccessful (612) the member is contacted or notified (614) and the process returns to bill entry 604. If the credit card processing is successful (612), the bill is processed (618) and the records payment release (632) is performed.

In the event that charges exceed $20.00 (step 606), members are sent an email detailing the pending charge and given a choice to either accept or reject the charge (Step 616). Members make this choice by clicking on the “accept” or “reject” button embedded within the email sent. If the member clicks the accept button, they will immediately be brought into their default web browser (e.g., Internet Explorer) where the charge will be processed and receipt information displayed (step 610). If the member opts to reject the charges, the operations staff will be immediately notified and the invoice and/or records will be returned unpaid and unprocessed.

The service provider's system retains the account number used for enrollment and will charge the same credit card for any copy charges encountered throughout the membership term. This information will be used at the charge member step 610. The amount and source of The charge, in addition to the number of records and the status of the request are included as details in the charge, and on the charge receipt.

In some cases, the credit card transaction does not complete successfully (612). This may be due to account closure, delinquency, or expiration. In this event, it will be necessary for the Operations staff to contact a member (614) directly in order to correct or verify payment information or to follow up an inquiry made by the member at some point in the process. The operations staff may override or replace the existing credit card information on an account in order to complete a transaction and may re-queue a bill afterwards, at their discretion.

Once credit card charges are processed (618), the records may be indexed and placed in a member's vault. This release process (632) also provides documentation of the transaction both within the system (via control logs) and to the member directly, in the form of a receipt for the transaction.

The bill processing 618 has several outputs including: sales receipt 630; A/R payment memo 626; and control logs 624. The sales receipt (630) is emailed to the subscriber at the successful conclusion of this process, after the credit card has been charge. The A/R payment memo 626 is formed for each transaction that is successfully processed, denoting the processing information from the credit card company and the approval codes they have provided. In this way the Accounts Receivable team is informed that they can enter the transaction into the payables stream so that a check can eventually be cut to pay the invoice. This memo accompanies the original invoice in a hand-off package that is routed to the Financial Department.

The control logs 624 are similar to those mentioned above for the other process steps. More particularly, the operations logs are updated to denote the processing of the bill and to provide a means of audit with the accounts receivable system, and a audit trail log which provides a record of the bill payment process to the subscriber.

Having described preferred implementations of a system and method for identifying the compatibility of users from identifying information gathered from web pages (which are intended to be illustrative and not limiting), it is noted that modifications and variations can be made by persons skilled in the art in light of the above teachings. It is therefore to be understood that changes may be made in the particular embodiments disclosed which are within the scope and spirit of the presented principles as outlined by the appended claims. Having thus described aspects of the present principles, with the details and particularity required by the patent laws, what is claimed and desired protected by Letters Patent is set forth in the appended claims.

What is claimed is:

1. A method for providing a medical records service comprising the steps of:
enrolling a patient, the enrolling comprising gathering information for at least one medical service provider of the patient;
receiving a records authorization to gather medical records for the patient;
requesting medical records from each of the medical services providers of the patient using the received records authorization;
recording receipt of and entering the requested medical records into a database; and
billing the patient for charges incurred in obtaining copies of the requested medical records.

2. The method of claim 1, further comprising:
requesting updated medical records from at least one of the medical service providers;
receiving the requested updated medical records; and
updating the medical records of the patient with the received updated medical records.

3. The method of claim 2, wherein medical records and updated medical records are requested automatically.

4. The method of claim 2, wherein the step of requesting updated medical records occurs in response to an event entered into an interactive healthcare calendar.

5. The method of claim 2, wherein said step of billing is performed automatically.

7. The method of claim 1, wherein the step of enrollment further comprises gathering a digital health profile of a patient.

8. A method for providing a medical records service for gathering and storing medical records of a patient, the method comprising the steps of:
enrolling a patient, the enrolling comprising gathering information for at least one medical service provider of the patient;
receiving a records authorization to gather medical records for the patient;
requesting updated medical records from at least one of the medical service providers using the received records authorization;
receiving the requested updated medical records;
updating the medical records of the patient with the received updated medical records; and
billing a patient for the costs incurred in connection with the requesting of updated medical records.

9. The method of claim 8, further comprising:
requesting medical records from each of the medical services providers of the patient using the received records authorization; and
receiving and entering the requested medical records into a database.

10. The method of claim 8, further comprising the step of copying and updating the medical records onto a portable records storage device.

11. The method of claim 8, wherein the step of requesting updated medical records occurs in response to the elapse of an event entered into an interactive healthcare calendar.
